(19) United States
(12) Patent Application Publication
(10) Pub. No.: US 2002/0196961 A1
(43) Pub. Date: Dec. 26, 2002

(54) PANEL-SHAPED LOUDSPEAKER

(76) Inventors: GUIDO O. M. D'HOOGH, DENDERMONDE (BE); DAVID M. E. CORYNEN, NEDERZWALM (BE)

Correspondence Address: EDWARD W GOODMAN, C/O U S PHILIPS CORPORATION, INTELLECTUAL PROPERTY DEPARTMENT, 580 WHITE PLAINS ROAD, TARRYTOWN, NY, 10591

(21) Appl. No.: 09/417,537

(22) Filed: Oct. 14, 1999

(30) Foreign Application Priority Data
Sep. 6, 1999 (EP) 99202868.8

(51) Int. Cl. H04R 1/00; H04R 9/06

(52) U.S. Cl. 381/431

(57) ABSTRACT

Panel-shaped loudspeaker comprising a panel (1) and an exciter coupled to the panel. The panel is provided with two parallel extending thin walls (1a, 1b) which are interconnected by means of a structure of thin strip-shaped partitions (1c) situated between the walls. The longitudinal axes of all partitions extend parallel to each other and give the panel an anisotropic bending stiffness. The material of the walls and the partitions, used in the panel, has an internal damping which is at least 2.5% of the critical damping of the relevant material, used in the panel.

The invention relates to a panel-shaped loudspeaker comprising a panel and at least an exciter coupled to the panel, said panel being provided with two, at least substantially parallel, interconnected walls.

A loudspeaker of this type is known from PCT patent application WO-A 97/09842.

The known panel-shaped loudspeaker comprises a panel having a sandwich-like structure and a rigid cellular core such as a honeycomb structure, and two skins glued to the core, which core extends between the skins. A light metal and a synthetic material are used as materials for the core. Paper, cardboard, synthetic material and light metal are mentioned as materials for the skins. The omnisided relatively rigid lightweight panel exhibits usable patterns of bending waves only at relatively high frequencies. In the known loudspeaker, one or more exciters are used which are arranged with respect to the panel in such a way that bending waves are produced only at relatively high frequencies. Due to reflections on the edges of the panel, bending waves which interfere with each other are spread across the panel. The known loudspeaker has a poor acoustical behavior in the low-frequency range.

It is an object of the invention to provide a panel-shaped loudspeaker which has a satisfactory acoustical behavior, both at relatively low frequencies and at higher frequencies.

This object is achieved with the loudspeaker according to the invention, which is characterized in that the panel comprises a structure of strip-shaped partitions extending between the walls of the panel, the longitudinal axes of all of said partitions mutually extending at least parallel to each other and parallel to the walls, said partitions being further secured to the walls, the walls and the partitions being made of a material which, used in the panel, has an internal damping which is at least 2.5% of the critical damping of the relevant material, used in the panel. Critical damping is herein understood to mean that damping at which the oscillating character of the panel stops.

Mechanically, the panel of the loudspeaker according to the invention is anisotropic, which panel can be bent around an axis extending parallel to said longitudinal axes and is relatively bending-stiff about an axis oriented transversely thereto. Surprisingly, it has been found that the loudspeaker according to the invention has a favorable acoustical behavior, both at low frequencies, central frequencies and high frequencies. It has been found by experiments that natural resonances already occur at relatively low frequencies in the panel of the loudspeaker according to the invention, which resonances have a smaller amplitude only at natural resonances occurring at relatively high frequencies, as compared with the loudspeaker known from said WO-A 97/09842. It is preferable not to exceed an internal damping of maximally 10% so as to avoid negative effects possibly occurring with larger dampings at higher frequencies. A very favorable acoustical behavior through a wide frequency range was found at an internal damping of 3% of the critical damping.

An embodiment of the loudspeaker according to the invention is characterized in that the partitions mutually extend at least substantially parallel and are at least substantially perpendicular to the walls for achieving an optimal anisotropy.

A practical embodiment of the loudspeaker according to the invention is characterized in that the material of the walls is equal to the material of the partitions. A further embodiment is characterized in that the walls and partitions blend seamlessly. In this embodiment, the walls and partitions constitute an integral unit manufactured, for example, by means of extrusion. Such a panel is obtainable in a simple manner and at low cost.

An embodiment of the loudspeaker according to the invention is characterized in that the material of the walls and the partitions of the panel is a polypropylene. The polypropylene is preferably a co-polymer.

An extruded, twin-walled plate of polypropylene co-polymer suitable as a panel is commercially available. Measurements proved that this material had an internal damping of 2.9% of the critical damping factor of the relevant material.

With reference to the claims, it is to be noted that various combinations of characteristic features defined in the dependent claims are possible.

These and other aspects of the invention are apparent from and will be elucidated with reference to the embodiments described hereinafter.

In the drawings:

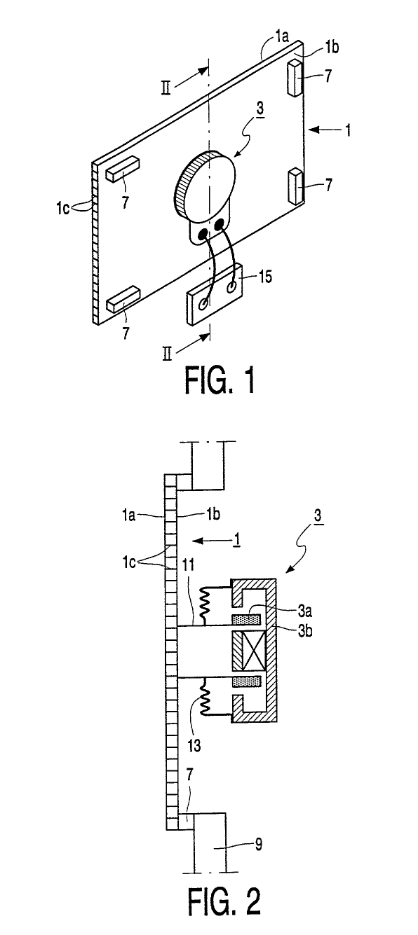

FIG. 1 is a diagrammatic rear view of an embodiment of the panel-shaped loudspeaker according to the invention,

FIG. 2 shows diagrammatically the embodiment shown in FIG. 1 (secured to a frame) in a cross-section taken on the line II-II, and

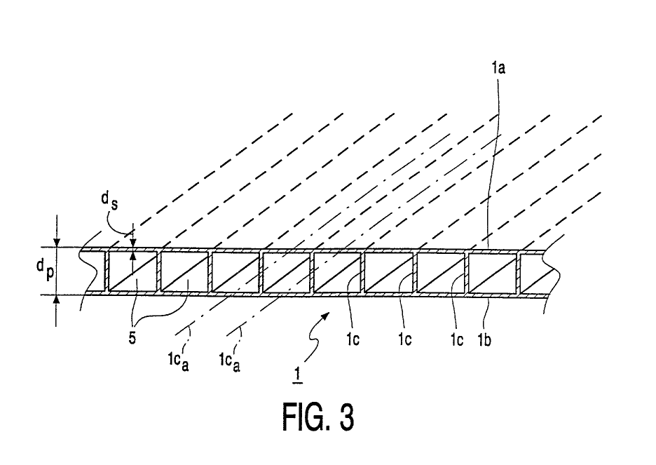

FIG. 3 shows diagrammatically in a cross-section taken on the line II-II a part of the panel of the embodiment on a larger scale.

The panel-shaped loudspeaker according to the invention, shown in the Figures, comprises a panel 1, particularly a flat panel, and an exciter 3 coupled to the panel 1. The panel 1 comprises two thin walls or main walls 1a and 1b, and a structure of thin strip-shaped partitions 1c situated between the two walls 1a and 1b and interconnecting the walls 1a and 1b.

The partitions 1c are oriented transversely to the walls 1a and 1b and the longitudinal axes 1cₐ of all of these partitions extend parallel to each other and parallel to the walls 1a and 1b. In this embodiment, the walls 1a and 1b and the partitions lc form one product, notably an extrusion product, formed from a polypropylene co-polymer. In the application shown, this material has an internal damping of 2.9%. In this embodiment, the panel 1 has a thickness dₚ of 1.5 mm and the walls 1a and 1b and partitions 1c have a thickness dₛ of 0.3 mm.

In this embodiment, the walls 1a and 1b together with the partitions 1c constitute parallel channels 5 having a rectangular, substantially square, cross-section. The panel 1 has an anisotropic bending stiffness. If additional damping is desired, a damping material such as a polyurethane foam may be selectively provided in the channels.

In this embodiment, the panel 1 is secured to a frame 9 by means of resilient securing means 7. In this embodiment, the exciter 3 is provided with an electromagnetic exciter system comprising an exciter coil 3a on a coil former 11 secured to the panel 1, and a magnetic unit 3b co-operating therewith through an air gap. The magnetic unit 3b comprises a permanent magnet and a magnetic yoke and is suspended to the coil former 11 by means of a resilient suspension means 13. The exciter 3 is also provided with electrical connection means 15.

It is to be noted that the invention is not limited to the shown embodiment of the panel-shaped loudspeaker according to the invention. For example, several variations are possible within the scope of the invention, notably as regards dimensions and choice of material. It is essential that the panel of the loudspeaker according to the invention has two parallel walls which are interconnected by means of a structure of parallel strip-shaped partitions, while the material used has a sufficiently high damping factor. Furthermore, an exciter system of a different type, particularly of a piezoelectric type, may be used instead of an electromagnetic exciter system.

The loudspeaker according to the invention may be used in audio, video and multimedia systems. The loudspeaker may also be used as a car loudspeaker and as a conference loudspeaker.

1. A panel-shaped loudspeaker comprising a panel and at least an exciter coupled to the panel, said panel being provided with two, at least substantially parallel, interconnected walls, characterized in that the panel comprises a structure of strip-shaped partitions extending between the walls of the panel, the longitudinal axes of all of said partitions extending at least parallel to each other and parallel to the walls, said partitions being further secured to the walls, the walls and the partitions being made of a material which, used in the panel, has an internal damping which is at least 2.5% of the critical damping of the relevant material, used in the panel.

2. A panel-shaped loudspeaker as claimed in claim 1, characterized in that the partitions mutually extend at least substantially parallel and are at least substantially perpendicular to the walls.

3. A panel-shaped loudspeaker as claimed in claim 1, characterized in that the material of the walls is equal to the material of the partitions.

4. A panel-shaped loudspeaker as claimed in claim 1, characterized in that the walls and partitions blend seamlessly.

5. A panel-shaped loudspeaker as claimed in claim 1, characterized in that the material is a polypropylene.

6. A panel-shaped loudspeaker as claimed in claim 5, characterized in that the polypropylene is a co-polymer.
